(19) United States
(12) Patent Application Publication
(10) Pub. No.: US 2012/0148403 A1
(43) Pub. Date: Jun. 14, 2012

(54) COUNTER-ROTATING VERTICAL AXIS WIND TURBINE ASSEMBLY

(75) Inventors: Richard A. Flaherty, Grapeview, WA (US); Christopher A. Burton, Bremerton, WA (US)

(73) Assignee: Leader International Corporation, Port Orchard, WA (US)

(21) Appl. No.: 13/316,146

(22) Filed: Dec. 9, 2011

Related U.S. Application Data
(60) Provisional application No. 61/421,941, filed on Dec. 10, 2010.

(51) Int. Cl. F03D 7/06; F03D 9/00

(52) U.S. Cl. 416/1; 290/55

(57) ABSTRACT

A vertically-oriented, counter-rotating wind turbine assembly is disclosed. The assembly can include two or more wind turbines, and each adjacent pair of wind turbines is configured to rotate oppositely. The wind turbines are separated by supporting plates, and include a rotor and a stator, respectively. The relative rotation of the rotor and stator generates electricity. The wind turbines are supported above and below by levitation and compression bearings, respectively. A motor can initiate rotation of the wind turbines when the ambient wind is below a break-in speed and above a steady state speed.

### CROSS REFERENCE TO RELATED APPLICATION

This non-provisional patent application hereby claims priority to Provisional Patent Application No. 61/421,941, titled Counter-Rotating Vertical Axis Wind Turbine Assembly, filed Dec. 10, 2010, which is hereby by incorporated herein in its entirety by reference thereto.

### TECHNICAL FIELD

The present disclosure is generally directed to counter-rotating, vertically-oriented, wind turbine assemblies and associated methods.

### BACKGROUND

There is an increasing demand for clean, renewable energy sources as we become more aware of the affect that mass energy consumption has on our environment. There are many sources of energy on Earth, but most of this energy is not harnessed. For example, solar energy and wind energy are abundant, but to date have not been adequately harvested and put to productive use without specialized and usually expensive equipment. Environmentally responsible energy production and harvesting methods unfortunately still compete in today's marketplace with energy sources that have a more harmful impact on the environment, such as fossil fuels. To be more competitive against fossil fuels, “green” energy sources must be as efficient as possible in terms of the energy they harvest, and in terms of the expense to build, operate, and maintain.

### SUMMARY

The present disclosure is directed to a counter-rotating, vertical wind turbine assembly. In one embodiment, the counter-rotating, vertical wind turbine assembly has two counter-rotating wind turbines axially aligned in a vertical orientation and rotatably disposed on a central shaft. The wind turbines each include two disks, one on top and one on bottom, with the vanes extending between the disks. The turbines rotate in opposite directions so the relative angular velocity of the turbines is equal to the sum of the magnitude of their respective angular velocities. In other words, defining the rotation of one turbine as positive and the rotation of the other turbine as negative, the relative angular velocity is equal to the difference between their respective angular velocities. The relative rotation is used to generate electricity in at least one embodiment due to a rotor on one turbine and a stator on the other turbine forming an alternator. The electricity generated in an alternator is generally proportional to the speed at which the rotor rotates relative to the stator. Accordingly, the counter-rotating turbines of the present disclosure can generate up to at least approximately twice the amount of energy produced by a single wind turbine rotating relative to a stationary reference. In one embodiment, the assembly includes two axially aligned, counter-rotating, vertical-axis wind turbines coupled to one or more single-rotation alternators to generate electricity from the relative movement between each turbine and a stationary support. The assembly 100 also includes a counter-rotation alternator to generate electricity from the relative motion between the counter-rotating wind turbines.

To support the wind turbines, the assembly can include a magnetic lift bearing underneath each wind turbine. The magnetic lift bearing supports the turbines without contacting the wind turbines, therefore reducing spinning resistance. In some embodiments, the magnetic lift bearings can include rare earth magnets, electromagnets, or other suitable magnets. The wind turbines can also have an upper compression magnetic bearing acting downward upon the turbines to help maintain the turbines in a steady rotation path. The compression force of the upper bearings is generally less than the levitation force of the lift bearings. In some embodiments, the upper compression bearings can be selectively activated and deactivated. Accordingly, the upper compression bearings can be switched on when the turbine has reached a selected rotational speed, and switched off when the turbine is stopped and/or during spin initiation, thereby reducing the initial resistance to start up rotation of the turbine.

In some embodiments, the assembly includes a solar-powered system to help spin one or more of the turbines. To overcome an inertial barrier to starting rotation of the turbine, the ambient wind must be above a certain level, called a break-in speed. However, the wind speed required for steady-state operation of the wind turbines is generally lower than the break-in speed. In some embodiments, the assembly includes a motor that starts the turbines spinning. This motor is powered by solar panels on the upper plate or in another exposed location of the assembly. The motor can also be powered by electricity stored in a battery or other suitable electrical storage device. The battery can be local with the assembly or (e.g., a rechargeable battery) or in some other location. In some embodiments, the present disclosure is directed to a method of initiating rotation of a wind turbine, comprising detecting an ambient wind speed around the wind turbine, and comparing the wind speed to a predetermined steady-state wind speed and to a break-in wind speed. If the wind turbines are not rotating, and if the wind speed is at or above the steady-state wind speed but below the break-in wind speed, the method can include rotating the wind turbines with a motor until the wind turbines reach a steady-state operating speed.

### BRIEF DESCRIPTION OF THE DRAWINGS

FIG. 1 is an isometric view of a wind turbine assembly in accordance with embodiments of the present disclosure.

FIG. 2 is an exploded, isometric view of a wind turbine assembly in accordance with embodiments of the present disclosure.

FIG. 3 is a side cross-sectional view of a wind turbine assembly comprising a nested alternator in accordance with embodiments of the present disclosure.

FIG. 4 is an exploded, isometric view of a wind turbine assembly in accordance with embodiments of the present disclosure.

FIG. 5 is a partially schematic side cross-sectional view of a wind turbine assembly in accordance with embodiments of the present disclosure.

FIG. 6 is a flow chart diagram of a method in accordance with embodiments of the present disclosure.

### DETAILED DESCRIPTION

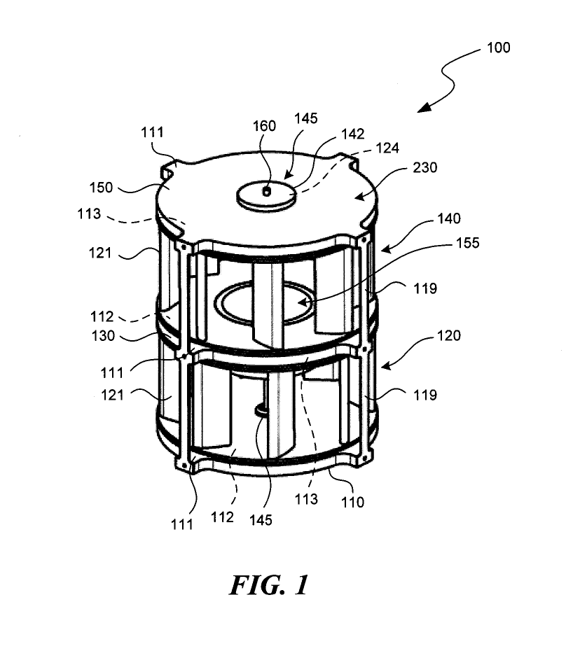

Various embodiments of wind turbine assemblies and methods of manufacturing and operation in accordance with an aspect of the disclosure are described below. A person skilled in the relevant art will also understand that the technology may have additional embodiments and that the technology may be practiced without several of the details of the embodiments described below with reference to FIGS. 1-6.

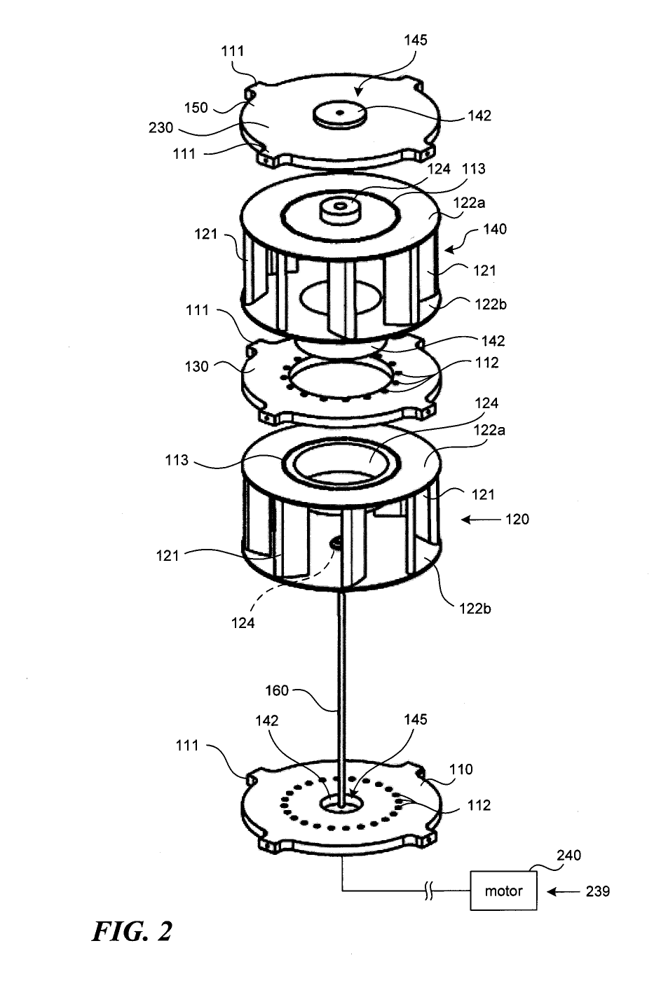

FIG. 1 of the illustrated embodiment is an isometric view of a counter-rotating, vertical-axis wind turbine (VAWT) assembly 100 in accordance with embodiments of the present disclosure. FIG. 2 is a partially schematic, exploded, isometric view of the VAWT assembly 100 of FIG. 1. The VAWT assembly 100 includes a lower plate 110, a lower wind turbine 120, a middle plate 130, an upper wind turbine 140, and an upper plate 150. A shaft 160 passes through the wind turbines 120, 140, and the plates 110, 130, and 150. The wind turbines 120, 140 include wind vanes 121 that cause the turbines 120, 140 to rotate around the shaft under pressure from passing wind. The vanes 121 in the respective turbines 120, 140 are oriented oppositely, so that wind causes the lower turbine 120 to rotate in one direction and the upper turbine 140 to rotate in an opposite direction due to different orientations of the vanes 121. The relative angular velocity of the turbines 120, 140 is equal to the difference between their respective angular velocities, defining rotation of the first turbine 120 as positive and the second turbine 140 a negative. In other words, the relative angular velocity is equal to the sum of the magnitude of the respective angular velocities. Assuming the turbines 120, 140 both rotate at the same speed, the relative angular velocity is twice the angular velocity relative to a stationary reference frame.

In the illustrated embodiment, the VAWT assembly 100 includes magnetic lift bearings 112 configured to magnetically suspend the lower turbine 120 above the lower plate 110 and to magnetically suspend the upper turbine 140 above the middle plate 130, thereby reducing rotational friction. In one embodiment, the magnetic lift bearing 112 for the lower turbine 120 is a two part bearing, with a first half that includes an annular magnet or collection of magnets imbedded or otherwise attached to the lower plate 110. The first half of the magnetic lift bearing 112 is axially aligned with the lower turbine. The second half of the magnetic lift bearing 112 is imbedded or otherwise attached to the bottom of the lower turbine 120. This second half of the magnetic lift bearing 112 is axially aligned and immediately adjacent to the bearing's first half, and is oriented to provide an opposing magnetic field the repels the magnetic field from the magnets in the bearing's first half. Accordingly, the two halves of the magnet lift bearing 112 provide repelling forces between the lower plate 110 and the lower turbine 120 sufficient to overcome the weight of the lower turbine and to suspend the lower turbine above the lower plate. A similar magnetic lift bearing 112 is provided on the middle plate 130 and the bottom of the upper turbine 140 to magnetically suspend the upper turbine above the middle plate. In some embodiments, the magnetic lift bearings 112 can be made of permanent rare-earth magnetic material. In other embodiments, the lift bearings 112 are made of electromagnets that can be switched on or off.

In at least one embodiment, the VAWT assembly 100 includes magnetic compression bearings 113 that provide compressive forces against the lower and upper turbines 120 and 140. The compression bearings 113 are tuned to help stabilize rotation of the lower and upper turbines 120 and 140, particularly at higher operating speeds. In illustrated embodiment one magnetic compression bearing 113 is provide between the middle plate 130 and the top of the lower turbine 120. Another magnetic compression bearing 113 is provided between the top plate 150 and the top of the upper turbine 140. The magnetic compression bearings 113 can be similar to the magnetic lift bearings discussed above. For example, an upper magnetic compression bearing 113 can include a first annular magnet ring in the top plate 150 and a second, opposing magnetic ring in the top of the upper turbine 140 immediately adjacent to and in axial alignment with the first annular magnet ring. The lower magnetic compression bearing 113 can include a first magnet ring in the middle plate 130 and an opposing magnetic ring in the top of the lower turbine 120 immediately adjacent to and in axial alignment with the first annular magnet ring.

The compression bearings 113 are configured to provide a slight compressive or downward force on the lower and upper turbines 120 and 140 that slightly counteract the levitation forces of the magnetic lift bearings 112, thereby helping to stabilize rotation of the turbines 120, 140. This compressive or downward force is less than the lifting force provided by the magnetic lift bearings 112, such that the magnetic compression bearings 113 do not overpower the magnetic lift bearings 112. In one embodiment, the lower magnetic compression bearing 113 can include the magnetic rings positioned radially inward or outward of the magnetic lift bearings 112 to avoid any potentially adverse magnetic interference between the bearings. In another embodiment, the magnetic compression bearings 113 and the magnetic lift bearings 112 can be spaced at approximately the same radial dimension from the central axis of rotation of the turbines. With the lift bearings 112 and compression bearings 113 in place, the turbines 120, 140 rotate about the shaft 160 without contacting any of the plates 110, 130, or 150, and in a steady, efficient path without substantial vertical oscillation during rotation.

In some embodiments, the assembly 100 includes a rotation-assist device 239, such as a motor 240 (FIG. 2), coupled to the turbines 120, 140 and configured to provide rotational assistance to the turbines 120, 140 when needed. The motor 240 can be used to help initiate or sustain rotation of the turbines 120, 140, particularly at low wind speeds. The wind speed necessary to initiate rotation of the wind turbines 120, 140 from a stopped position is called the “break-in speed.” The break-in speed is generally higher than the minimum steady state speed at which the wind turbines 120, 140 will continue to rotate. The concept is similar to static friction being greater than dynamic friction. When ambient wind is at or above the steady state speed, but below the break-in speed and the wind turbines 120, 140 will remain stopped, thereby losing an opportunity to convert the energy to useful power. The motor 240 is configured to provide assistance to begin rotation of the wind turbines 120, 140 up to the steady-state speed when ambient wind will continue the rotation of the wind turbines 120, 140. The motor 240 can also be configured to help maintain rotation of the wind turbines 120, 140, particularly when the wind speed is fluctuating above and below the break-in speed or the steady state speed to maintain rotation. While the above-described embodiment uses a motor 240 as the rotation-assist device, other embodiments can use other rotation assist devices 239, such as an electro-magnetic-assist device configured to provide a rotational force to one or both wind turbines, particularly when the wind speed is below the break-in speed.

The rotation-assist device 239, such as the motor 240, can be powered by solar panels 230 placed on top of the upper plate 150, on or adjacent to the supports, or in another location, including a location spaced apart from the assembly. The rotation-assist device 239 can also be powered by energy from an electrical grid to which the assembly 100 is coupled, or by energy generated by the wind turbines 120, 140 and stored in a battery or other power storage device. In some embodiments, the rotation-assist device 239 draws power from one or more of these sources to rotate only the first wind turbine 120 or only the second wind turbine 140 until the assembly 100 reaches a state where sufficient energy is being produced to rotate other wind turbines in the assembly 100.

The vanes 121 of the turbines 120, 140 have an airfoil configuration, with a front side having a longer airflow surface than a back side. This creates a pressure differential that rotates the wind turbines 120, 140. The turbines 120, 140 are rotated by wind passing in any direction across the turbines 120, 140. This directional independence allows the turbine assembly 100 to be used where wind is present but is not necessarily oriented in a predictable direction. More details on the shape, size, operation, and configuration of vanes for a wind turbine are given in U.S. Pat. No. 5,083,039 and U.S. Pat. No. 7,452,185, both of which are incorporated herein by reference in their entirety.

In some embodiments, the bottom plate 110 and top plate 150 of the assembly 100 cooperate with the lower and upper turbines 120, 140, respectively, to provide single-rotation alternators 145 for generating electricity. The rotation of the turbines 120 and 140 relative to the bottom and top plates 110 and 150, respectively, is used to generate electricity from the rotation of the turbines 120, 140 caused by the wind passing through the turbines 120, 140. Each single-rotation alternator 145 includes a stator 124 and a rotor 142. The single-rotation alternator 145 for the lower turbine can include the stator 124 or the rotor 142 on the bottom plate 110, and the other one of the rotor 142 or stator 124 is coupled to the bottom of the lower turbine 120. Similarly, a single-rotation alternator 145 for the upper turbine can include the stator 124 or rotor 142 on the top plate 110, and the other of the rotor 142 or stator 124 on the top of the upper turbine 140. In at least one embodiment, the single-rotation alternators 145 can include electro-magnetic devices so that the alternators can be selectively turned on and off. In other embodiments, the single-rotation alternators 145 can include fixed magnets, such as rare-earth magnets.

The assembly 100 of the illustrated embodiment includes a counter-rotation alternator 155 coupled to the lower and upper turbines 120, 140 to produce electricity from the relative rotation between the lower turbine 120 and the upper turbine 140, as discussed above. In one embodiment, the lower turbine 120 includes a stator 124 and the upper turbine 140 comprises a rotor 142. The stator 124 is an interior surface of the turbine 120 that receives the rotor 142 which appends from the upper turbine 140 and extends down through an annulus 131 of the middle plate 130. In another embodiment, the upper turbine 140 includes the stator 124 and the lower turbine 120 comprises a rotor 142. The assembly 100 having the counter-rotation alternator 155 can be included in embodiments that also have one or more of the single-rotation alternators 145 discussed above. In other embodiments, the assembly 100 can include just one or more of the single-rotation alternators 145 or just the counter-rotation alternator 155. In at least one embodiment, the counter-rotation alternator 155 can include electro-magnetic devices so that the alternator can be selectively turned on and off. In other embodiments the counter-rotation alternator 155 can utilize fixed magnets, such as rare-earth magnets. The terms “rotor” and “stator” are used herein to refer to the respective roles of the equipment in the alternator configuration. The term “stator” in some alternator terminology can mean that the stator is stationary and does not rotate. In the embodiments shown in FIGS. 1 and 2, the stator 124 rotates relative to a stationary reference frame and relative to the rotor 142.

In some embodiments, the wind turbine assembly 100 is scalable and can include three, four, or more vertically stacked wind turbines, each separated by a plate and aligned on one or more coaxial central shafts. For purposes of illustration, however, the assembly 100 is described having two wind turbines 120, 140. The plates 110, 130, and 150 can have several tabs 111 extending outwardly from a circumference of the plates 110, 130, and 150. The tabs 111 can be attached to a supporting bracket 119 (FIG. 1) that can hold the plates 110, 130, and 150 in place relative to the wind turbines 120, 140. The supporting brackets work with the plates 110, 130, 150 to provide a sturdy frame or sub-structure that securely and fixedly holds the assembly in a stable arrangement. The sub-structure can be mounted in a desirable location to expose the assembly's wind turbines to the wind. For example, the sub-structure of the assembly 100 can be mounted on top of a tall pole or other support structure to position the assembly in an elevated location relative to the ground, a building, or other support surface.

These turbines 120, 140 of the assemblies 100 provide substantial benefits over conventional Horizontal-Axis Wind Turbines (HAWT). For example, the wind turbines 120, 140 in the VAWT assemblies 100 are less susceptible to damage from bird strikes, because the spinning vanes 121 are visible to birds, so the birds do not try to fly through the turbines. The blades of conventional HAWTs move such that birds can see through or past the spinning blades, thereby giving the appearance to the birds that they can fly through the spinning blades. The VAWT assembly 100 also requires a smaller footprint and spacing relative to adjacent VAWT assemblies 100. Conventional HAWT's typically require a very large foot print and spacing between adjacent HAWTs.

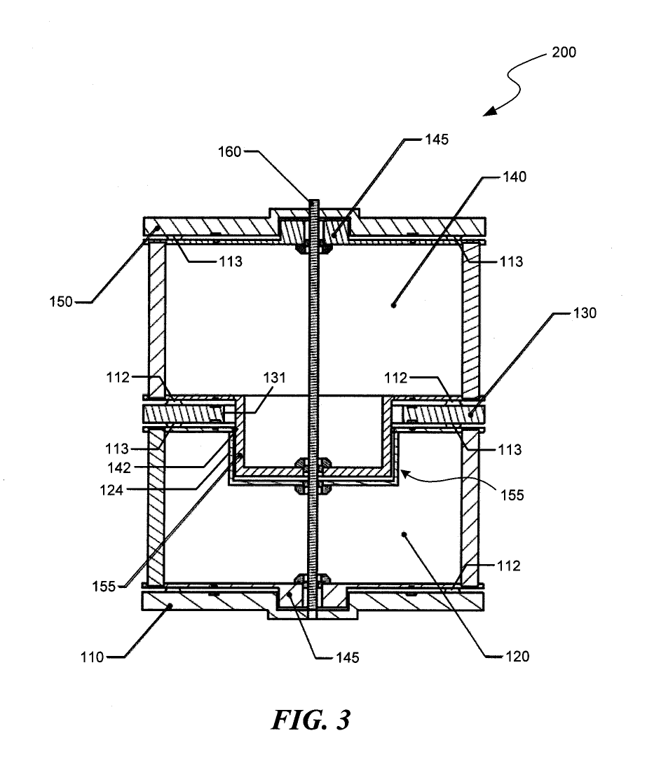

FIG. 3 is a side view of a wind turbine assembly 200 in accordance with embodiments of the present disclosure. Several of the features of the assembly 200 are similar to the embodiments of the assembly 100 discussed above with reference to FIG. 1. Like reference numerals are used in FIGS. 1, 2, and 3 where appropriate. In this embodiment, the middle plate 130 includes an annulus 131, and the second wind turbine 140 can include a rotor 142. The first wind turbine 120 can have a stator 124 that receives the rotor 142. The rotor 142 and the stator 124 can form a nested alternator that generates electricity when the first wind turbine 120 and second wind turbine 140 counter-rotate. As mentioned above, the terms “rotor” and “stator” refer more appropriately to the roles these components play in the alternator, and not to the fact that rotors conventionally rotate and stators conventionally do not. The affect of the counter-rotating wind turbines 120, 140, and their respective rotor 142 and stator 124 is to provide a greater relative angular velocity of the rotor 142 and stator 124.

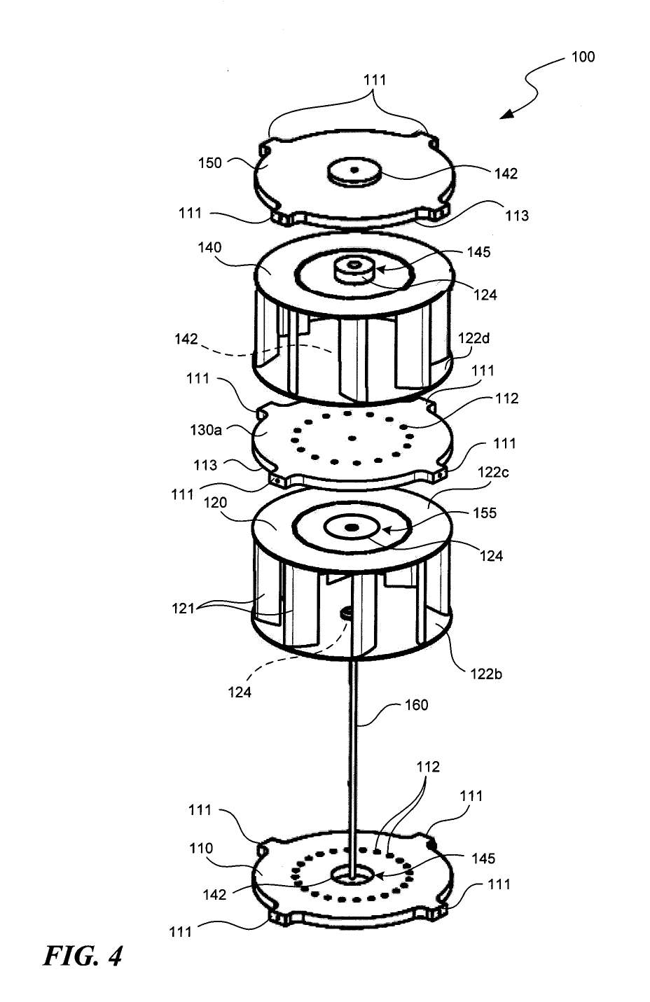

FIG. 4 is an exploded view of other embodiments of a vertically-oriented counter-rotating wind turbine assembly 300 according to the present disclosure. The assembly 300 includes a lower plate 110, a lower turbine 120, a middle plate 130a, an upper turbine 140, and an upper plate 150 generally similar to the assemblies 100, 200 discussed above. In this embodiment, the middle plate 130a is a flat plate without a central hole. The upper turbine 140 does not include the downward projecting rotor 142. Rather, the upper turbine 140 and lower turbine 120 rotate relative to the middle plate 130a to generate electricity. The middle plate 130a includes levitation bearings 112 on a top side and compression bearings 113 on a bottom side.

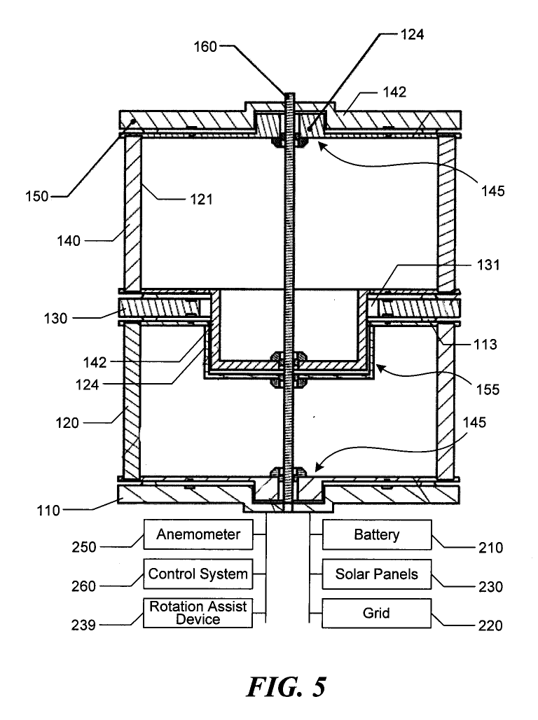

FIG. 5 is a side view of a wind turbine assembly 300 according to several embodiments of the present disclosure. The assembly 300 can be similar to the embodiments discussed above with reference to FIGS. 1-4. Similar reference numerals are used in FIG. 5. FIG. 5 schematically shows a battery 210, an electrical grid 220, solar panels 230, a motor 240, an anemometer 250, and a control system 260. The battery 210 can be used to store electricity produced by the assembly 300. Any appropriate battery type can be used, and can be scaled to accommodate the size of the assembly 300. The electrical grid 220 can be a municipal electrical grid. The assembly 300 can be configured to deliver electricity to the grid, and in some cases described herein, to draw electricity from the grid 220. The solar panels 230 can be used in connection with the wind turbine to generate electricity as conventional solar panels, and also to power the motor 240 in a manner described more fully below. The solar panels 230 can be placed on the upper plate 150 and can be at least generally coextensive with the plate to maximize available exposed space. Alternatively, the solar panels 230 can be located elsewhere.

The control system 260 of the illustrated is coupled to the anemometer 250, and the control system uses wind speed information from the anemometer 250 to determine when and how much electricity needs to be drawn from the solar system and/or the battery (or other electricity storage device) to initiate rotation of one or both of the turbines 120, 140. In one embodiment, one or more of the alternators 145 and 155 is an electromagnetic device that can be turned on and off, and the control system 260 is configured to selectively turn one or more of the alternators on and off based upon the rotational speed of the wind turbines 120, 140 and/or the wind speed (determined by the anemometer 250). For example, the control system 260 can turn off the alternators 145 and/or 155 when the wind speed drops below the break-in speed or when rotational speed of the wind turbines 120, 140 is approaching the minimum steady-state speed. When the alternators 145, 155 are turned off, they do not create additional resistance to rotation of the turbines 120, 140. When the wind speed and/or rotational speed is greater than a selected speed (i.e., the break-in speed), such that the rotation of the wind turbines 120, 140 can overcome additional resistance to rotation, the control system 260 can turn on one or more of the alternators 145, 155, so as to begin generating electricity from the alternators.

In one embodiment, the control system 260 is configured to sequentially stagger the activation of the alternators 145, 155 based upon wind speed and rotational speed of the turbines 120, 140. For example, the alternators 145, 155 are off when the wind turbines 120, 140 are stopped. When the wind speed is at or above the break-in speed and the turbines 120, 140 are rotating (either with or without assistance from the motor 240 or the other rotation-assist device), the control system 260 turns on or otherwise activates at least one of the single-rotation alternators 145. When the wind speed is at or above the steady-state speed, the other single-rotation alternator 145 and/or the counter-rotation alternator 155 are turned on to maximize power generation from the spinning turbines 120, 140. The control system 126 can also be configured to activate the compression bearings 113, discussed above, before or after activation of the alternators 145, 155 to maintain smooth and efficient turbine rotation.

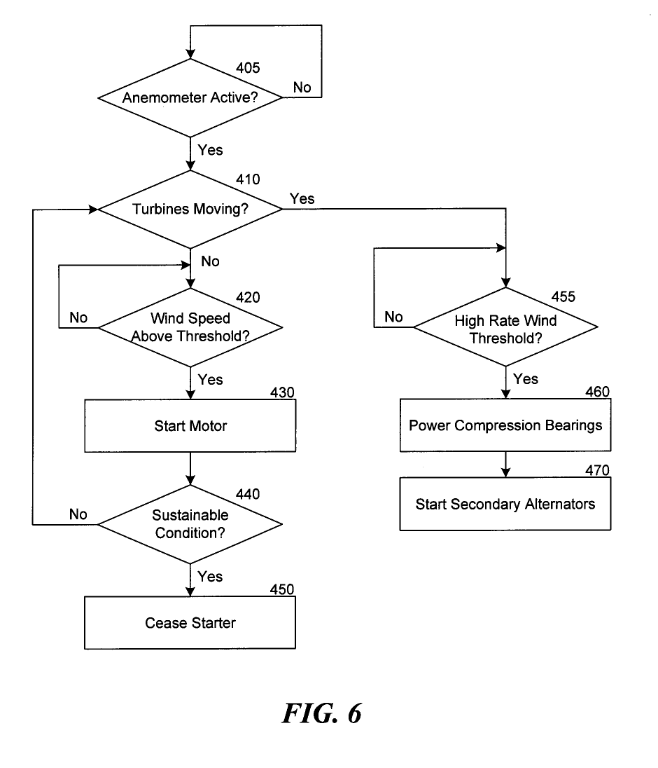

FIG. 6 is a flow chart of a method 400 of initiating rotation of the wind turbine assemblies 100, 200, and 300 shown above according to the present disclosure. As discussed above, the break-in speed for wind turbine assemblies is generally higher than a steady state speed. The method 400 can be executed by a controller 260 as shown in FIG. 6, such as a programmable logic controller. In step 405, the controller 260 (FIG. 4) determines whether the anemometer 250 (FIG. 4) is active so as to determine the wind speed. If the anemometer 250 is active, the controller 260 determines in step 410 whether the turbines 120, 140 are still or moving. The method 400 can include a periodic check of wind turbine speed and/or wind speed, or a sensor can measure turbine speed to determine when the turbines 120, 140 stop rotating. At step 420 the controller determines whether the ambient wind is strong enough to sustain rotation of the wind turbines 120, 140 if they were rotating. In some embodiments, this check can be performed by the anemometer 250 (FIG. 4) and reported to the controller 260. If the wind is not strong enough, the method 400 can include a periodic check of wind speed. When the wind speed is measured approximately at or above a sustainable level above the steady state speed, at which point the method 400 can include starting a motor 240 at step 430 to rotate one or more of the wind turbines 120, 140. The motor 240 can be activated to help initiate rotation of wind turbines 120, 140 independently or simultaneously. At step 440, the method 400 can include a check of whether the wind is still blowing above the steady state speed. If so, the motor 240 can cease at step 450. If the wind has dropped below the steady state speed, however, the method 400 can return to step 410 and the process repeats. Step 440, checking for a sustainable condition, can include a wait period to ensure an accurate check and to prevent a momentary wind drop from stopping the method 400. The time of the wait period can depend on the environment in which the wind turbine operates. If ambient wind is reasonably predictable and stable, the wait period can be shorter than for wind turbines in other places where wind is less reliable.

If the controller determines, at step 410, that the turbines are moving, the controller can determine at step 455 whether the wind speed, as measured by the anemometer, is at or above a high-rate wind threshold. If the wind speed is at or above the high wind threshold, which can indicate substantially sustained rotation of the turbines at a sufficient speed, the controller can be configured, at step 460, to power or otherwise activate the compression bearings 113, discussed above. As discussed above, the wind turbine assemblies 100, 200, and 300 can include magnetic lift bearings 112 and magnetic compression bearings 113. In some applications, the bearings can have an effect on required the break-in speed. To overcome this, the compression bearings 113 can include electromagnets that can be switched on and off. The compression bearings 113 can be switched off when the turbines 120, 140 are stopped so as to lower the break-in speed. The compression bearings can also be switched off or remain off when the rotational speed of the turbines is close to the minimum steady state speed. The method 400 can power the compression bearings 113 thereby activating the compressive forces on one or both wind turbines 120, 140 when wind turbines are rotating at or above a selected speed relative to the minimum steady state speed. In another embodiment, the compression bearings 113 can be turned on and off based upon the measured wind speed. For example, if the measured wind speed drops below a threshold level, the compression bearings 113 can be turned off to allow the wind turbines to continue spinning with less resistance while the wind speed is low, thereby taking advantage of the inertia of the spinning turbines in low wind speed conditions.

The method 400 can also include a step 470 of powering or otherwise activating one or more of the alternators 145 and/or 155 when the controller determines at step 455 that the wind speed is at or above the high wind threshold. The controller can be configured to activate the counter-rotating alternator 155 without activating the single-rotating alternators 145. The controller 260 can also be configured to turn on or otherwise activate the single-rotation alternators 145 sequentially (e.g., as a function of the wind speed), or simultaneously. The controller 260 can also be configures to activate all of the alternators 145, 155 substantially simultaneously, such as when the wind speed is high enough, thereby spinning both turbines and generating the maximum energy from the assembly via the single-rotation alternators 145 and the counter-rotation alternator 155. The controller 260 can also be configured to selectively turn off the alternators when the wind speed and/or the turbines' rotational speed drop below one or more threshold values, thereby maximizing the efficiency of the energy generation by the assembly.

From the foregoing, it will be appreciated that specific embodiments of the invention have been described herein for purposes of illustration, but that various modifications may be made without deviating from the spirit and scope of the invention. Additionally, aspects of the invention described in the context of particular embodiments or examples may be combined or eliminated in other embodiments. Although advantages associated with certain embodiments of the invention have been described in the context of those embodiments, other embodiments may also exhibit such advantages. Additionally not all embodiments need necessarily exhibit such advantages to fall within the scope of the invention.

We claim:

1. A wind turbine assembly, comprising:
a shaft oriented at least generally vertically;
a lower plate oriented at least generally horizontally with the shaft passing through a portion of the lower plate;
a first wind turbine adjacent to the lower plate, the first wind turbine comprising a plurality of vertically-oriented air foil vanes arranged at a periphery of the first wind turbine, wherein the vanes are shaped such that wind passing over the vanes causes the first wind turbine to rotate in a first direction relative to the shaft;
a middle plate adjacent to the first wind turbine and oriented at least generally horizontally with the shaft passing through a portion of the middle plate;
a second wind turbine adjacent to the middle plate, the second wind turbine being substantially similar to the first wind turbine, wherein the second wind turbine has a plurality of air-foil vanes shaped such that wind passing over the vanes causes the second wind turbine to rotate in a second direction relative to the shaft;
a rotor on the first wind turbine;
a stator on the second wind turbine, wherein the rotor and stator are configured to rotate relative to one another to generate electricity; and
an upper plate adjacent to the second wind turbine and oriented at least generally horizontally with the shaft passing through a portion of the upper plate.

2. The wind turbine assembly of claim 1 wherein the middle plate comprises a first middle plate, and wherein the assembly further comprises a third wind turbine and a second middle plate between the second wind turbine and the third wind turbine.

3. The wind turbine assembly of claim 1 wherein the upper plate comprises a solar panel.

4. The wind turbine assembly of claim 1 wherein:
the median plate comprises an annulus,
the rotor extends downward from the upper turbine through the annulus, and
the stator comprises a recession in the first wind turbine configured to receive the rotor.

5. A method of initiating rotation of a wind turbine, comprising:
detecting an ambient wind speed around the wind turbine;
comparing the wind speed to a predetermined steady-state wind speed and to a break-in wind speed; and
if the wind turbines are not rotating, and if the wind speed is at or above the steady-state wind speed but below the break-in wind speed, rotating the wind turbines with a motor until the wind turbines reach a steady-state operating speed.
